(19) United States
(12) Patent Application Publication
(10) Pub. No.: US 2014/0348509 A1
(43) Pub. Date: Nov. 27, 2014

(54) FIBER-OPTIC COMMUNICATION APPARATUS AND FIBER-OPTIC COMMUNICATION TERMINAL INCORPORATING THE SAME

(71) Applicants: TRANSYSTEM INC., Hsinchu City (TW); AMOESOLU CORPORATION, Taipei City (TW)

(72) Inventors: Lee-Chuan Chang, Hsinchu County (TW); Wen-Jye HUANG, Taipei City (TW); Chuang-Chun CHIOU, Taipei City (TW); Cheng-Yen CHEN, Taipei City (TW)

(73) Assignees: TRANSYSTEM INC., Hsinchu City (TW); AMOESOLU CORPORATION, Taipei City (TW)

(21) Appl. No.: 14/096,690

(22) Filed: Dec. 4, 2013

(30) Foreign Application Priority Data
May 24, 2013 (TW) 102118441

(51) Int. Cl. H04B 10/2575

(52) U.S. Cl. CPC H04B 10/2575
USPC 398/116; 398/115

(57) ABSTRACT

A fiber-optic communication apparatus includes a modulator, a combiner and an electro-optic converter. The modulator modulates a number (N) of radio frequency (RF) signals with the same frequency respectively into a number (N) of modulated signals with mutually different frequencies, where N≧2. The combiner is coupled to the modulator for combining the modulated signals therefrom into a combined signal that has a number (N) of components with mutually different frequencies. The electro-optic converter is coupled to the combiner for converting the combined signal therefrom into an optical signal that has a number (N) of components with mutually different frequencies.

### CROSS-REFERENCE TO RELATED APPLICATION

This application claims priority of Taiwanese Application No. 102118441, filed on May 24, 2013, the contents of which are hereby incorporated by reference.

### BACKGROUND OF THE INVENTION

1. Field of the Invention

This invention relates to fiber-optic communication, and more particularly to a fiber-optic communication apparatus and a fiber-optic communication terminal incorporating the same.

2. Description of the Related Art

Referring to FIG. 1, a conventional fiber-optic communication system is shown to include a transmitting terminal 100, a receiving terminal 200, and an optical fiber cable 300 coupled between the transmitting and receiving terminals 100, 200.

The transmitting terminal 100 includes a processor 11, a number (N) of electro-optic converters 12, and an optical multiplexer 13, where N≧2. The processor 11 generates a number (N) of radio frequency (RF) signals with mutually different frequencies (f₁-f_{N}). Each electro-optic converter 12 is coupled to the processor 11 for converting a respective RF signal received therefrom into an optical signal. The number (N) of the optical signals thus generated respectively by the electro-optic converters 12 have mutually different frequencies. The optical multiplexer 13 has a number (N) of input ends coupled respectively to the electro-optic converters 12 for receiving respectively the optical signals therefrom, and an output end coupled to the optical fiber cable 300. The optical multiplexer 13 is operable to combine the optical signals received respectively at the input ends into a combined optical signal that has a number (N) of components with mutually different frequencies, and outputs the combined optical signal at the output end. Thereafter, the combined optical signal is transmitted to the receiving terminal 200 through the optical fiber cable 300.

The receiving terminal 200 includes an optical demultiplexer 21, a number (N) of optic-electro converters 22 and a number (N) of antennas 23. The optical demultiplexer 21 has an input end coupled to the optical fiber cable 300 for receiving the combined optical signal from the output end of the optical multiplexer 13 of the transmitting terminal 100, and a number (N) of output ends. The optical demultiplexer 21 is operable to split the combined optical signal into a number (N) of optical signals that have mutually different frequencies and that are respectively outputted at the output ends of the optical demultiplexer 21. The optic-electro converters 22 are coupled respectively to the output ends of the optical demultiplexer 21 for receiving respectively the optical signals therefrom. Each optic-electro converter 22 converts the respective optical signal received thereby into an RF signal. The number (N) of the RF signals thus generated respectively by the optic-electro converters have mutually different frequencies (f₁-f_{N}). The antennas 23 are coupled respectively to the optic-electro converters 22 such that the RF signal generated by each optic-electro converter 2 is radiated by a respective antenna 23.

However, the electro-optic converters 12, the optic-electro converters 22, the optical multiplexer 13 and the optical demultiplexer 21 are relatively expensive. As a result, the conventional fiber-optic communication system has a relatively high cost, which increases rapidly with increasing N.

### SUMMARY OF THE INVENTION

Therefore, an object of the present invention is to provide a fiber-optic communication apparatus and a fiber-optic communication terminal incorporating the same that can overcome the aforesaid drawbacks associated with the prior art.

According to one aspect of this invention, a fiber-optic communication apparatus comprises a modulator, a combiner and an electro-optic converter. The modulator is adapted for modulating a number (N) of radio frequency (RF) signals with the same frequency respectively into a number (N) of modulated signals with mutually different frequencies, where N≧2. The combiner is coupled to the modulator for combining the modulated signals therefrom into a combined signal that has a number (N) of components with mutually different frequencies. The electro-optic converter is coupled to the combiner for converting the combined signal therefrom into an optical signal that has a number (N) of components with mutually different frequencies.

According to another aspect of this invention, a fiber-optic communication apparatus comprises an optic-electro converter and a signal regenerating unit. The optic-electro converter is adapted for converting an optical signal that has a number (M) of components with mutually different frequencies, into a composite signal that has a number (M) of components with mutually different frequencies, where M≧2. The signal regenerating unit is coupled to the optic-electro converter for receiving the composite signal therefrom. The signal regenerating unit is operable to generate a number (M) of output signals with the same frequency based on the composite signal. Each of the output signals is associated with a respective one of the components of the composite signal.

According to yet another aspect of this invention, a fiber-optic communication terminal comprises a processor and a fiber-optic communication apparatus. The processor is operable to generate a number (N) of radio frequency (RF) signals with the same frequency, where N≧2. The fiber-optic communication apparatus includes a modulator, a combiner and an electro-optic converter. The modulator is coupled to the processor for modulating the RF signals therefrom respectively into a number (N) of modulated signals with mutually different frequencies. The combiner is coupled to the modulator for combining the modulated signals therefrom into a combined signal that has a number (N) of components with mutually different frequencies. The electro-optic converter is coupled to the combiner for converting the combined signal therefrom into an optical signal that has a number (N) of components with mutually different frequencies.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a schematic circuit block diagram illustrating a conventional fiber-optic communication system;

FIG. 2 is a schematic circuit block diagram illustrating the first preferred embodiment of a fiber-optic communication system according to this invention;

FIG. 3 is a spectrum diagram illustrating a combined signal of the fiber-optic communication system of the first preferred embodiment; and

FIG. 4 is a schematic circuit block diagram illustrating the second preferred embodiment of a fiber-optic communication system according to this invention.

### DETAILED DESCRIPTION OF THE PREFERRED EMBODIMENTS

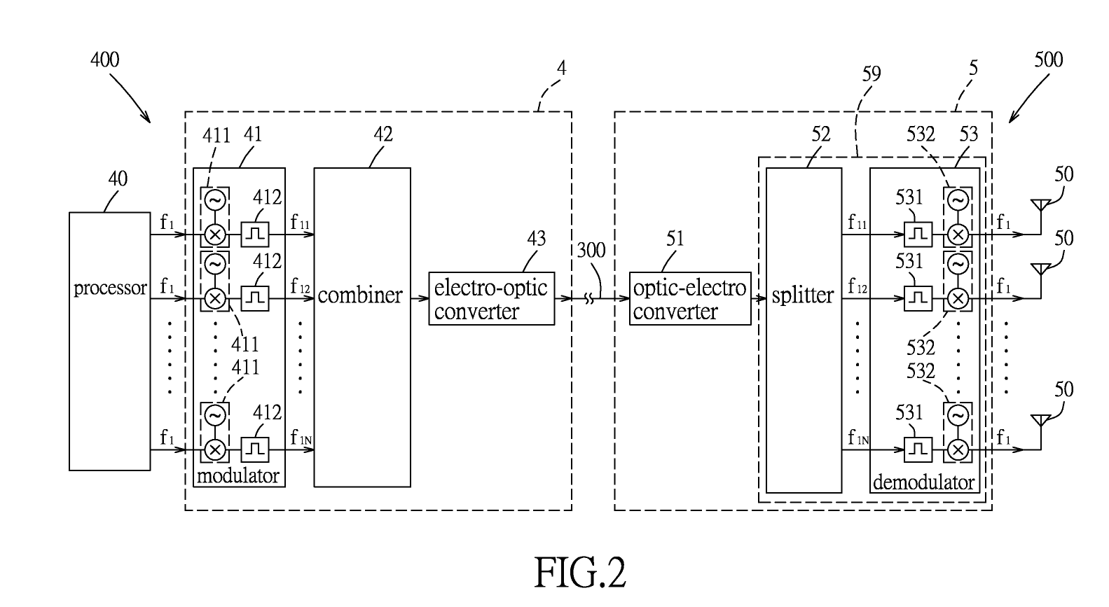

Referring to FIG. 2, the first preferred embodiment of a fiber-optic communication system according to this invention is shown to include a first fiber-optic communication terminal 400, a second fiber-optic communication terminal 500, and an optical fiber cable 300 coupled between the first and second fiber-optic communication terminals 400, 500. The optical fiber cable 300 provides a single optical transmission channel.

The first fiber-optic communication terminal 400 includes a processor 40 and a first fiber-optic communication module 4. The processor 40 is operable to generate a number (N) of radio frequency (RF) signals with the same frequency (f₁), where N≧2. The first fiber-optic communication module 4 includes a modulator 41, a combiner 42 and an electro-optic converter 43. The modulator 41 is coupled to the processor 40 for modulating the RF signals therefrom respectively into a number (N) of modulated signals with mutually different frequencies (f₁-f_{1N}). The combiner 42 is coupled to the modulator 41 for combining the modulated signals therefrom into a combined signal that has a number (N) of components with mutually different frequencies. The electro-optic converter 43 is coupled between the combiner 42 and the optical fiber cable 300. The electro-optic converter 43 is operable to convert the combined signal from the combiner 42 into an optical signal that has a number (N) of components with mutually different frequencies, and outputs the optical for transmission to the second fiber-optic communication terminal 500 via the optical fiber cable 300.

In this embodiment, the modulator 41 includes a number (N) of frequency converters 411, and a number (N) of band pass filters 412. Each of the frequency converters 411 is coupled to the processor 40 for converting a respective one of the RF signals therefrom into a frequency converted signal. Each of the band pass filters 412 is coupled to a respective one of the frequency converters 411 for filtering the frequency converted signal therefrom to generate a respective one of the modulated signals.

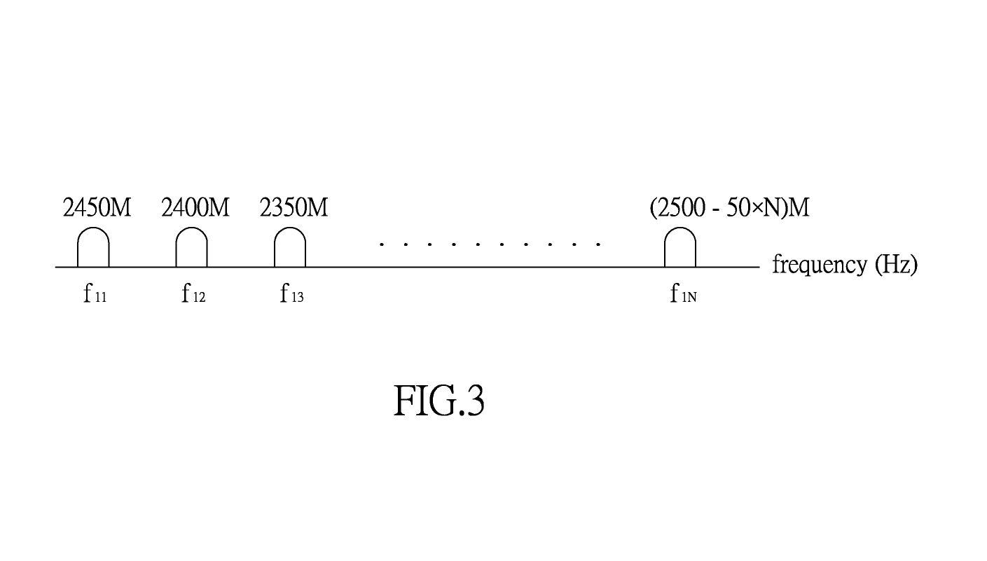

For example, the frequency (f₁) of each of the RF signals is 2500 MHz. A first one of the frequency converters 411 down-converts the respective one of the RF signals into the frequency converted signal with the frequency (f₁₁) of 2450 MHz. A second one of the frequency converters 411 down-converts the respective one of the RF signals into the frequency converted signal with the frequency (f₁₂) of 2400 MHz. A third one of the frequency converters 411 down-converts the respective one of the RF signals into the frequency converted signal with the frequency (f₁₃) of 2350 MHz. Similarly, an i^{th} one of the frequency converters 411 down-converts the respective one of the RF signals into the frequency converted signal with the frequency (f₁ᵢ) of (2500-50×i) MHz, where 1≦i≦N. Accordingly, each of the band pass filters 412 has a pass band around a respective one of the frequencies (f₁₁-f_{1N}), which are 2450 MHz, 2400 MHz, 2350 MHz, . . . , and (2500-50×N) MHz, respectively. As a result, each of the modulated signals has a respective one of the frequencies (f₁₁-f_{1N}), which are 2450 MHz, 2400 MHz, 2350 MHz, . . . , and (2500-50×N) MHz, respectively, and thus each of the components of the combined signal has a respective one of the frequencies (f₁₁-f_{1N}), which are 2450 MHz, 2400 MHz, 2350 MHz, . . . , and (2500-50×N) MHz, respectively, as shown in FIG. 3.

The second fiber-optic communication terminal 500 includes a second fiber-optic communication module 5 and a number (N) of antennas 50 coupled to the second fiber-optic communication module 5. The second fiber-optic communication module 5 includes an optic-electro converter 51 and a signal regenerating unit 59. The optic-electro converter 51 is coupled to the optical fiber cable 300 for converting the optical signal from the electro-optic converter 43 of the first fiber-optic communication module 4 of the first fiber-optic communication terminal 400 into a composite signal that has a number (N) of components with mutually different frequencies. The signal regenerating unit 59 is coupled to the optic-electro converter 51 for receiving the composite signal therefrom. The signal regenerating unit 59 is operable to generate a number (N) of output signals with the same frequency (f₁) based on the composite signal. Each of the output signals is associated with a respective one of the components of the composite signal, and is to be radiated by a respective antenna 50.

In this embodiment, the signal regenerating unit 59 includes a splitter 52 and a demodulator 53. The splitter 52 has an input end coupled to the optic-electro converter 51 for receiving the composite signal therefrom, and a number (N) of output ends. The splitter 52 splits the composite signal into a number (N) of split signals that have mutually different frequencies (f₁₁-f_{1N}) and that are outputted respectively at the output ends of the splitter 52. The demodulator 53 is coupled to the output ends of the splitter 52 for demodulating the split signals therefrom respectively into the output signals. The demodulator 53 includes a number (N) of band pass filters 531 and a number (N) of frequency converters 532. Each of the band pass filters 531 is coupled to a respective output end of the splitter 52 for filtering a respective one of the split signals therefrom to generate a filtered signal. Each of the frequency converters 532 is coupled to a respective one of the band pass filters 531 for converting the filtered signal therefrom into a respective one of the output signals.

For example, each of the split signals has a respective one of the frequencies (f₁₁-f_{1N}), which are 2450 MHz, 2400 MHz, 2350 MHz, . . . , and (2500-50×N) MHz, respectively. Each of the band pass filters 531 has a pass band around a respective one of the frequencies (f₁₁-f_{1N}), which are 2450 MHz, 2400 MHz, 2350 MHz, . . . , and (2500-50×N) MHz, respectively. Each of the output signals has the frequency (f₁) of 2500 MHz. A first one of the frequency converters 532 up-converts the filtered signal with the frequency (f₁₁) of 2450 MHz into the respective one of the output signals. A second one of the frequency converters 532 up-converts the filtered signal with the frequency (f₁₂) of 2400 MHz into the respective one of the output signals. A third one of the frequency converters 532 up-converts the filtered signal with the frequency (f₁₃) of 2350 MHz into the respective one of the output signals. Similarly, a j^{th} one of the frequency converters 532 up-converts the filtered signal with the frequency (f₁ⱼ) of (2500-50×j) MHz into the respective one of the output signals, where 1≦j≦N.

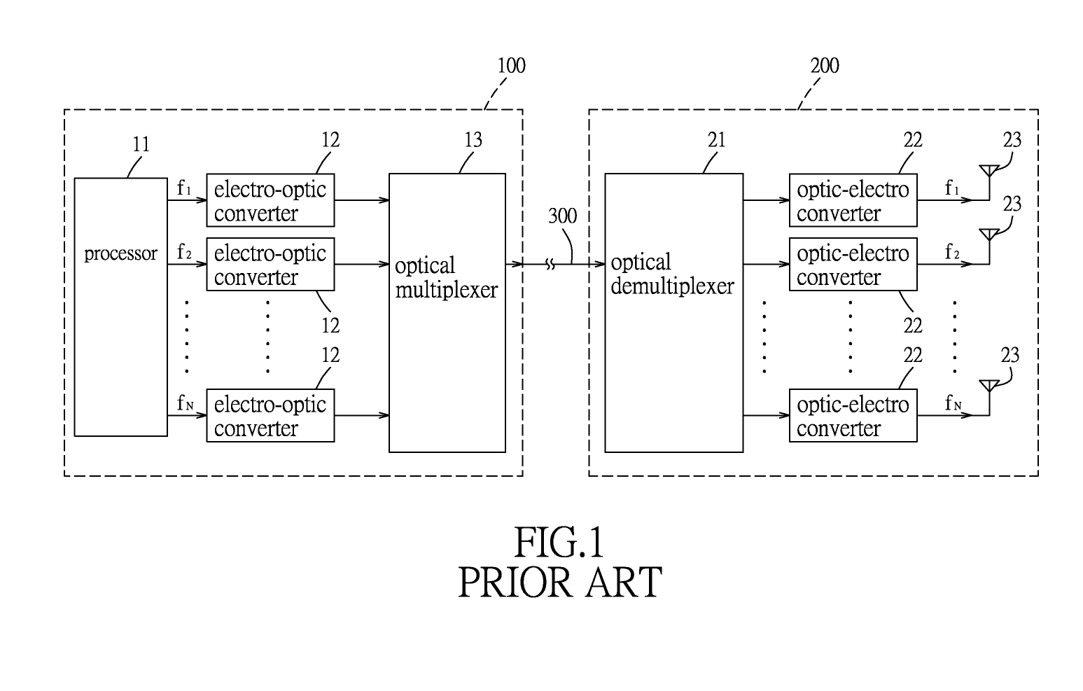

In view of the above, by using the combiner 42 to combine the modulated signals and using the signal regenerating unit 59 to separate the composite signal both in the electric domain instead of in the optical domain, the single electro-optic converter 43 and the single optic-electro converter 52 are merely required for the fiber-optic communication system of this embodiment to achieve communication between the first and second fiber-optic communication terminals 400, 500 via the optical fiber cable 300. In addition, the frequency converters 411, 532, the band pass filters 412, 531, the combiner 42 and the splitter 52 are relatively cheap compared to the electro-optic converter 43, the optic-electro converter 51, the optical multiplexer 13 of FIG. 1, and the optical demultiplexer 21 of FIG. 1. Therefore, compared to the conventional fiber-optic communication system of FIG. 1, the fiber-optic communication system of this embodiment has a relatively low cost, which increases less rapidly with increasing N.

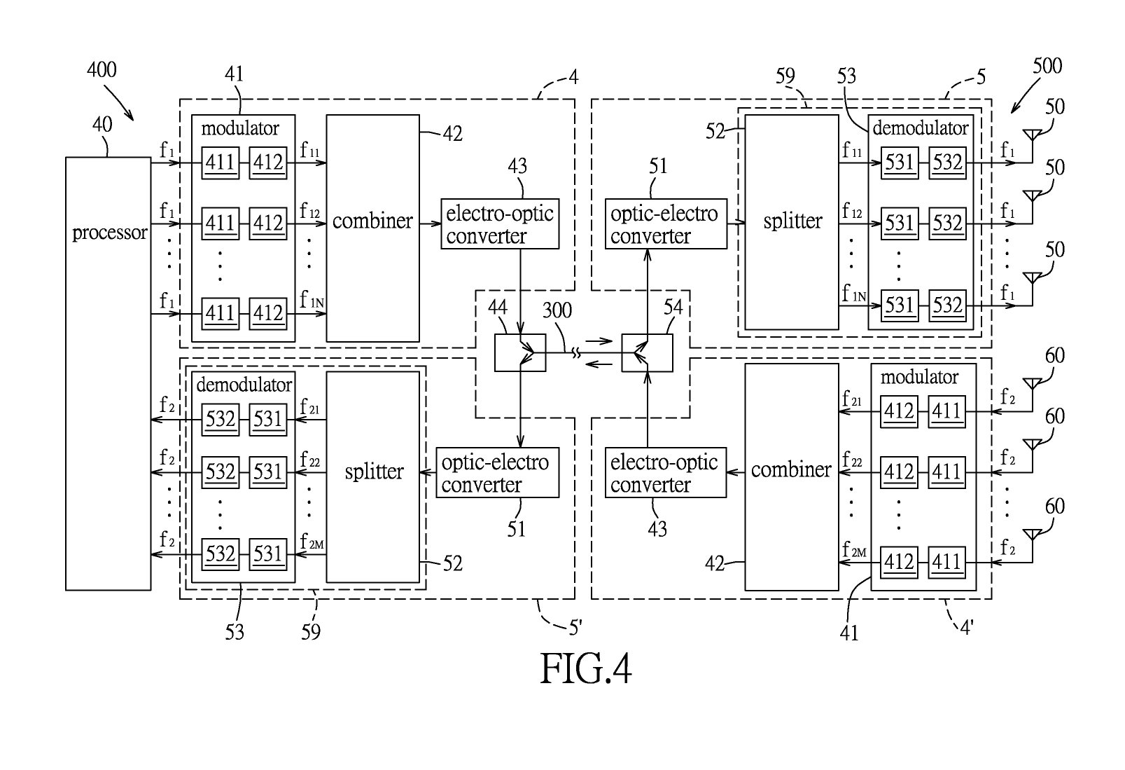

FIG. 4 illustrates the second preferred embodiment of a fiber-optic communication system according to this invention, which is a modification of the first preferred embodiment. Unlike the first preferred embodiment, the first fiber-optic communication terminal 400 of the second preferred embodiment further includes another second fiber-optic communication module 5′ similar to the second fiber-optic communication module 5 of the second fiber-optic communication terminal 500 and coupled to the processor 40, and a signal director 44 coupled among the first and second fiber-optic communication modules 4, 5′ and the optical fiber cable 300. The first and second fiber-optic communication modules 4, 5′ and the signal director 44 cooperatively constitute a fiber-optic communication apparatus. In addition, the second fiber-optic communication terminal 500 further includes a number (M) of antennas 60, another first fiber-optic communication module 4′ similar to the first fiber-optic communication module 4 of the first fiber-optic communication terminal 400 and coupled to the antennas 60, and a signal director 54 coupled among the first and second fiber-optic communication modules 4′, 5 and the optical fiber cable 300, where M≧2. The first and second fiber-optic communication modules 4′, 5 and the signal director 54 cooperatively constitute another fiber-optic communication apparatus.

The optical signal generated by the first fiber-optic communication module 4 serves as a first optical signal. The signal director 44 transmits the first optical signal from the first fiber-optic communication module 4 to the optical fiber cable 300. The signal director 54 transmits the first optical signal passing through the optical fiber cable 300 to the second fiber-optic communication module 5. Each antenna 60 receives an RF signal with a frequency (f₂), which is different from the frequency (f₁) in this embodiment. It is noted that, in other embodiments, the frequency (f₂) can be identical to the frequency (f₁). The first fiber-optic communication module 4′ generates, based on a number (M) of the RF signals received respectively by the antennas 60, a second optical signal that has a number (M) of components with mutually different frequencies. The signal director 54 transmits the second optical signal from the first fiber-optic communication module 4′ to the optical fiber cable 300. The signal director 44 transmits the second optical signal passing through the optical fiber cable 300 to the second fiber-optic communication module 5′. The second fiber-optic communication module 5′ generates, based on the second optical signal from the signal director 44, a number (M) of output signals with the same frequency (f₂), and outputs the output signals to the processor 40.

Moreover, the processor 40 is adapted to be coupled to at least one signal source 60, such as a digital broadcasting receiver, an Ethernet card, or a wireless access point, etc. In this embodiment, the processor 40 is coupled to two signal sources 60 for receiving two input signals therefrom, respectively. The processor 40 is operable to convert the input signals into two of the RF signals, respectively.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A fiber-optic communication apparatus comprising:
a modulator adapted for modulating a number (N) of radio frequency (RF) signals with the same frequency respectively into a number (N) of modulated signals with mutually different frequencies, where N≧2;
a combiner coupled to said modulator for combining the modulated signals therefrom into a combined signal that has a number (N) of components with mutually different frequencies; and
an electro-optic converter coupled to said combiner for converting the combined signal therefrom into a first optical signal that has a number (N) of components with mutually different frequencies.

2. The fiber-optic communication apparatus of claim 1, wherein said modulator includes:
a number (N) of frequency converters each adapted for converting a respective one of the RF signals into a frequency converted signal; and
a number (N) of band pass filters, each of which is coupled to a respective one of said frequency converters for filtering the frequency converted signal therefrom to generate a respective one of the modulated signals.

3. The fiber-optic communication apparatus of claim 1, further comprising:
an optic-electro converter adapted for converting a second optical signal, which has a number (M) of components with mutually different frequencies and which is transmitted through a single optical transmission channel to said optic-electro converter, into a composite signal that has a number (M) of components with mutually different frequencies, where M≧2;
a signal regenerating unit coupled to said optic-electro converter for receiving the composite signal therefrom, said signal regenerating unit being operable to generate a number (M) of output signals with the same frequency based on the composite signal, each of the output signals being associated with a respective one of the components of the composite signal; and
an optical director optically coupled between said electro-optic converter and said optic-electro converter for transmitting the first optical signal from said electro-optic converter to the single optical transmission channel and transmitting the second optical signal from the single optical transmission channel to said optic-electro converter.

4. The fiber-optic communication apparatus of claim 3, wherein said signal regenerating unit includes:
a splitter coupled to said optic-electro converter for splitting the composite signal therefrom into a number (M) of split signals with mutually different frequencies; and
a demodulator coupled to said splitter for demodulating the split signals therefrom respectively into the output signals.

5. The fiber-optic communication apparatus of claim 4, wherein said demodulator of said signal regenerating unit includes:
a number (M) of band pass filters, each of which is coupled to said splitter for filtering a respective one of the split signals therefrom to generate a filtered signal; and
a number (M) of frequency converters, each of which is coupled to a respective one of said band pass filters for converting the filtered signal therefrom into a respective one of the output signals.

6. A fiber-optic communication apparatus comprising:
an optic-electro converter adapted for converting an optical signal that has a number (M) of components with mutually different frequencies, into a composite signal that has a number (M) of components with mutually different frequencies, where M≧2; and
a signal regenerating unit coupled to said optic-electro converter for receiving the composite signal therefrom, said signal regenerating unit being operable to generate a number (M) of output signals with the same frequency based on the composite signal, each of the output signals being associated with a respective one of the components of the composite signal.

7. The fiber-optic communication apparatus of claim 6, wherein said signal regenerating unit includes:
a splitter coupled to said optic-electro converter for splitting the composite signal therefrom into a number (M) of split signals with mutually different frequencies; and
a demodulator coupled to said splitter for demodulating the split signals therefrom respectively into the output signals.

8. The fiber-optic communication apparatus of claim 7, wherein said demodulator includes:
a number (M) of band pass filters, each of which is coupled to said splitter for filtering a respective one of the split signals therefrom to generate a filtered signal; and
a number (M) of frequency converters, each of which is coupled to a respective one of said band pass filters for converting the filtered signal therefrom into a respective one of the output signals.

9. A fiber-optic communication terminal comprising:
a processor operable to generate a number (N) of radio frequency (RF) signals with the same frequency, where N≧2; and
a fiber-optic communication apparatus including
a modulator coupled to said processor for modulating the RF signals therefrom respectively into a number (N) of modulated signals with mutually different frequencies,
a combiner coupled to said modulator for combining the modulated signals therefrom into a combined signal that has a number (N) of components with mutually different frequencies, and
an electro-optic converter coupled to said combiner for converting the combined signal therefrom into an optical signal that has a number (N) of components with mutually different frequencies.

10. The fiber-optic communication terminal of claim 9, wherein said processor is adapted to be coupled to a signal source for receiving an input signal therefrom, and is operable to convert the input signal into one of the RF signals.
